(19) United States
(12) Patent Application Publication
(10) Pub. No.: US 2024/0412334 A1
(43) Pub. Date: Dec. 12, 2024

(54) PROCESSOR-AWARE OPTIMIZATIONS FOR ON-DEVICE ACCELERATION OF DIFFUSION MODELS

(71) Applicant: Google LLC, Mountain View, CA (US)

(72) Inventors: Raman Sarokin, Zurich (CH); Yu-Hui Chen, Cupertino, CA (US); Juhyun Lee, San Jose, CA (US); Jiuqiang Tang, Cupertino, CA (US); Chuo-Ling Chang, Mountain View, CA (US); Andrei Kulik, Zurich (CH); Matthias Grundmann, San Jose, CA (US)

(21) Appl. No.: 18/735,050

(22) Filed: Jun. 5, 2024

Related U.S. Application Data
(60) Provisional application No. 63/507,339, filed on Jun. 9, 2023.

(51) Int. Cl. G06T 5/60; G06T 1/20; G06T 5/70

(52) U.S. Cl. CPC G06T 5/60; G06T 1/20; G06T 5/70; G06T 2207/20084

(57) ABSTRACT

Systems, methods, devices, and related techniques for accelerating execution of diffusion models or of other neural networks that involve similar operations. Some aspects include accelerating inference computations in neural networks, including inference computations utilized in denoising (also referred to as “diffusion”) neural networks.

### CROSS-REFERENCE TO RELATED APPLICATIONS

This application claims the benefit of priority under 35 U.S.C. § 119(e) to U.S. provisional application Ser. No. 63/507,339, filed Jun. 9, 2023, the entire contents of which are incorporated by reference herein.

### BACKGROUND

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Large diffusion models are a class of neural networks that have gained significant attention for their ability to generate photorealistic images and support various tasks. On-device deployment of these models provides benefits such as lower server costs, offline functionality, and improved user privacy. However, large diffusion models commonly include a large number of parameters (e.g., in excess of 1 billion parameters) that pose challenges due to limited computational and memory resources on devices.

### SUMMARY

This specification generally describes systems, methods, devices, and related techniques for accelerating execution of diffusion models and other neural networks that employ similar operations.

In a first aspect, a method is provided for accelerating operations in a denoising (diffusion) neural network. The method can be performed on one or more computers in one or more locations, but the optimizations in the method can allow the method to be performed on a user device such as a GPU-equipped mobile phone. A data item that is to be denoised is identified. The data item can be processed with a denoising neural network to generate a denoised version of the data item. The denoising neural network can include a self-attention mechanism, and generating the denoised version of the data item can include invoking the self-attention mechanism to process a set of attention inputs to generate an attention output. The attention output can include (i) obtaining a query matrix Q that contains elements representing a set of queries q, a key matrix K that contains elements representing a set of keys k, and a value matrix V that contains elements representing a set of values v corresponding to the set of keys k and (ii) generating an attention matrix A by calculating a product of the query matrix Q and the key matrix K. Additional detail on the use of queries, keys, and values are in a self-attention mechanism is described, for example, in U.S. Pub. 2018/0341860 (“Attention-based sequence transduction neural networks”, filed Jun. 28, 2018, published Nov. 29, 2018), and in Vaswani et al., “Attention is All You need” (2017), available at https://arxiv.org/abs/1706.03762. The entire contents of both papers are incorporated by reference into the disclosure of the present specification.

Rather than performing a softmax function directly on the larger attention matrix A, the method can include executing a first, single compiled program module such as a first dedicated GPU shader that calculates, for each row in the attention matrix A, a respective maximum value L among the elements in the row and a modified exponential sum S for the elements in the row. The respective maximum values L and the respective modified exponential sums S are stored in a reduced matrix R. A second, single compiled program module such as a second dedicated GPU shader can then be executed that both performs an element-wise softmax function on the elements of the reduced matrix R and that multiplies the result of the element-wise softmax function by the value matrix V to produce the attention output.

In a second aspect, another method is provided for accelerating operations in a denoising (diffusion) neural network. The method can again be performed on one or more computers in one or more locations, but the optimizations in the method can allow the method to be performed on a user device such as a GPU-equipped mobile phone. A conditioning input is received that characterizes one or more desired properties for the data item. The data item can be iteratively updated to generate a final version of the data item having the one or more desired properties characterized by the conditioning input. More specifically, the iterative updating can include a series of updating iterations, and in each updating iteration, a denoising neural network is used to denoise a current version of the data item at the updating iteration to generate a denoised version of the data item for the updating iteration. The denoising operations in each iteration can include performing each of multiple group normalization functions by executing a first, single compiled program module such as a first GPU shader that performs an entirety of the group normalization function without writing any intermediate tensor generated during performance of the group normalization function to non-register memory. Additionally, or alternatively, the denoising operations in each iteration can include performing each of multiple activation functions by executing a second, single compiled program module such as a second GPU shader that performs an entirety of the activation function without writing any intermediate tensor generated during performance of the activation function to non-register memory. The denoising is guided at least in part by the conditioning input, and the final version of the data item can be provided for output. For example, the final version of the data item can be an image or text that is displayed to a user, stored in memory, or transmitted or made accessible to another computing system for further processing.

As noted above, large diffusion models commonly include a large number of parameters (e.g., in excess of 1 billion parameters) that pose challenges due to limited computational and memory resources on devices. The techniques described in this specification addresses these challenges through optimizations that can significantly accelerate processing of diffusion models, consequently improving the ability of such models to be practically executed on a wide range of GPU-equipped user devices.

Additional aspects of the present disclosure include systems that have one or more processors and one or more non-transitory computer-readable media encoded with instructions that, when executed by the one or more processors, cause the one or more processors to perform operations of the disclosed methods.

### BRIEF DESCRIPTION OF THE DRAWINGS

FIG. 1 illustrates an example environment for performing a model on a computing device.

FIG. 2 illustrates an example method for generating a denoised version of the data item.

FIG. 3 illustrates an example method for producing the attention output.

FIG. 4 illustrates an example method for generating a final version of the data item having one or more desired properties characterized by the conditioning input.

FIG. 5 illustrates an example method for generating a denoised version of a data item for an updating iteration.

FIG. 6 illustrates a schematic diagram of a text-to-image model.

FIG. 7 illustrates an example equation.

FIG. 8 illustrates example implementations for applying softmax within an attention module.

### DETAILED DESCRIPTION

This specification generally describes systems, methods, devices, and related techniques for accelerating execution of diffusion models or of other neural networks that involve similar operations.

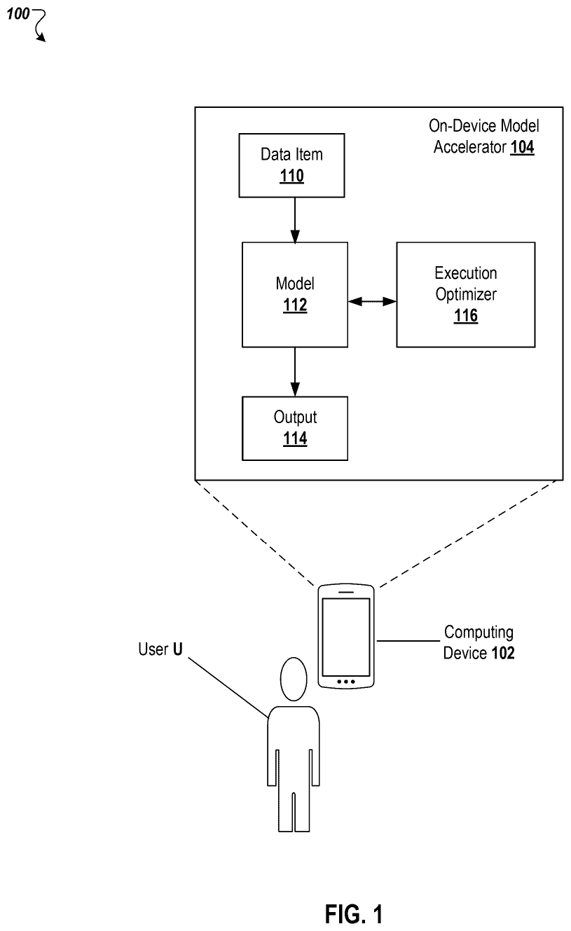

FIG. 1 illustrates an example environment for running a model 112, which can include machine learning models such as large diffusion models, on a computing device 102. The environment 100 includes a computing device 102, which can be operated by the user U.

The computing device 102 can be a mobile computing device such as a smart phone, tablet, laptop, VR device, or smart home hub. The computing device 102 is generally has significantly less computational resources than computers in data centers and servers that have often been used to execute large diffusion models offline (e.g., such as stable diffusion). The computing device 102 includes an on-device model accelerator 104 to execute some or all processes with such models locally on the computing device 102. Executing such models on the computing device 102 provides several advantages including reduced server costs, improved scalability, reduced latency, offline functionality, and improved user privacy due to local data processing.

The model 112 is a machine learning model that processes the data item 110 to generate an output 114. In some examples, the model 112 is a diffusion model. In some examples, the diffusion model is a text-to-image model, such as Stable Diffusion. However, the same techniques can be applied to other diffusion models.

In different examples, the data item 110 can be an image, audio signal, and/or a text sample depending on the model 112. The output 114 can include data stored in the computing device 102, output displayed (e.g., as an image or text) on a display of the computing device 102, output played (e.g., via audio and/or video output) on the computing device 102, or combinations thereof. In some examples, the output 114 is provided to a decoding model for conversion from an embedding space to a text, image, audio, or video data item.

The on-device model accelerator 104 implements one or more techniques to improve the performance (e.g., speed of execution) of a model on the computing device 102 using the model optimizer 116. In some examples, the model optimizer 116 uses GPU-aware optimizations. These optimizations are applied to the model 112 to improve the speed and/or reduce the memory requirements for processing the data item 110 with the model 112 to produce the output 114. Some of these examples include applying one or more softmax functions to the model. In some examples, Winograd Convolution is used to reduce multiplications resulting in faster processing and lower power consumption (particularly by GPUs). In some examples a FlashAttention algorithm is used which considers hardware settings for improved performance. These techniques, as well as other optimization techniques, are described further herein.

In some examples, the computing device 102 is configured to interface with a network to electronically communicate with other computing systems. In some examples, the optimization techniques disclosed herein include at least some steps which are performed by a remote computing system that interfaces with the computing device 102 via the network (e.g., such as a cellular network, other wireless network). In some examples, the network includes a public network, such as the Internet.

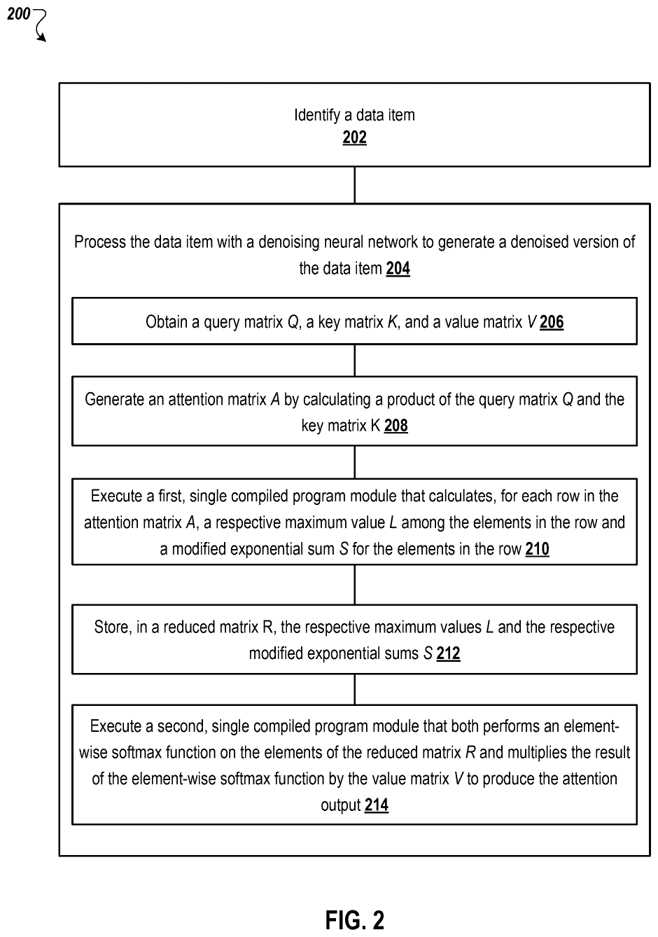

FIG. 2 illustrates an example method 200 for generating a denoised version of the data item. In some examples, the method 200 is performed by a system with one or more processors and non-transitory computer-readable media (e.g., memory) encoded with instructions that when executed by the one or more processors, cause the one or more processors to perform the method 200. Some examples include non-transitory computer-readable media encoded with instructions that cause one or more processors executing the instructions to perform the method 200. The method 200 includes the operations 202 and 204.

At the operation 202, the computing device identifies a data item. Examples of the data item include an image, an audio signal, or a text sample.

At the operation 204, the computing device processes the data item with a denoising neural network to generate a denoised version of the data item. The denoising neural network defines a self-attention mechanism. In some examples, generating the denoised version of the data item includes invoking the self-attention mechanism to process a set of attention inputs to generate an attention output (e.g., as shown in the sub-operations 206, 208, 210, 212, and 214). In some implementations, the data item is iteratively denoised to generate a final denoised version of the data item. The iterative denoising can be guided by a conditioning input that characterized the one or more desired properties for denoising the data item.

In some examples, the operation 204 includes performing multiple convolution operations. Some or all of the multiple convolution operations can be carried out using Winograd convolution. In some examples, the Winograd convolution is selectively performed on a subset of the multiple convolution operations.

The operation 204 includes the sub-operations 206, 208, 210, 212, and 214. As discussed, in some examples, the operations 206, 208, 210, 212, and 214 are executed iteratively.

At the sub-operation 206, the computing device obtains a query matrix Q, a key matrix K, and a value matrix V. The Q matrix contains elements representing a set of queries. The key matrix K contains elements representing a set of keys k. The value matrix contains elements representing a set of values v corresponding to the set of keys k.

At the sub-operation 208, the computing device generates an attention matrix A by calculating a product of the query matrix Q and the key matrix K. In some examples, generating the attention matrix A involves calculating a scaled product of the query matrix Q and a transposed version of the key matrix K.

At the sub-operation 210, the computing device executes a first, single compiled program module that calculates, for each row in the attention matrix A, a respective maximum value L among the elements in the row and a modified exponential sum S for the elements in the row. In some examples, the first, single compiled program module is implemented as a graphics processing unit (GPU) shader. In some of these examples, the GPU shader is operable to calculate all of the L and S values for storage in the reduced matrix R responsive to a single GPU command without writing any intermediate tensors to non-register memory in the course of calculating all of the L and S values.

At the sub-operation 212, the computing device stores, in a reduce matrix R, the respective maximum values L and the respective modified exponential sums S. In some examples, the reduced matrix R has fewer elements than the attention matrix A and performing the element-wise softmax function on the reduce matrix is less computational expensive than if the element-wise softmax function were performed on the attention matrix A.

At the sub-operation 214, the computing device executes a second single compiled program module that both performs an element-wise softmax function on the elements of the reduced matrix R and multiplies the result of the element-wise softmax function by the value matrix V to produce the attention output. In some examples, the second, single compiled program module is implemented as a graphics processing unit (GPU) shader. In some of these examples, the GPU shader is operable to both perform the element-wise softmax function on the elements of the reduced matrix R and multiply the result of the element-wise softmax function by the value matrix V to produce the attention output responsive to a single GPU command without writing any intermediate tensors to non-register memory in the course of calculating all of the L and S values.

The final denoised version of the data item can be provided as output from the model. Examples of providing the final denoised version of the data item includes storing the final denoised version of the data item in a memory device, displaying the final denoised version of the data item as an image, playing the final denoised version of the data item as an audio or video stream, presenting the final denoised version of the data item as text, or providing the final denoised version of the data item to a decoding model for conversion from an embedding space to a text, image, audio, or video data item.

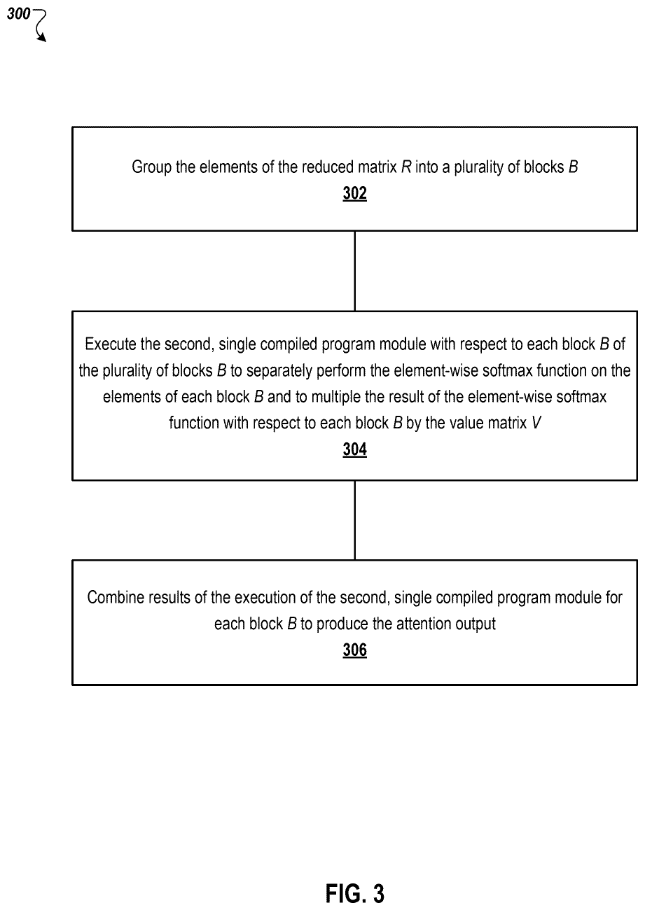

FIG. 3 illustrates an example method 300 for producing the attention output. In some examples, the method 300 is performed with the method 200 illustrated and described in FIG. 2. The method 300 includes the operations 302, 304, and 306.

At the operation 302, the computing device groups the elements of the reduced matrix R into multiple blocks B.

At the operation 304, the computing device executes the second, single compiled program module with respect to each block B of the multiple blocks B to separately perform the element-wise softmax function on the elements of each block B and to multiple the result of the element-wise softmax function with respect to each block B by the value matrix V. In some examples, the second, single compiled program module that is executed with respect to each block B is executed on a different processing device. In some examples, at least some of the executions for different blocks B are parallelized.

At the operation 306, the computing device combines results of the execution of the second, single compiled program module for each block B to produce the attention output.

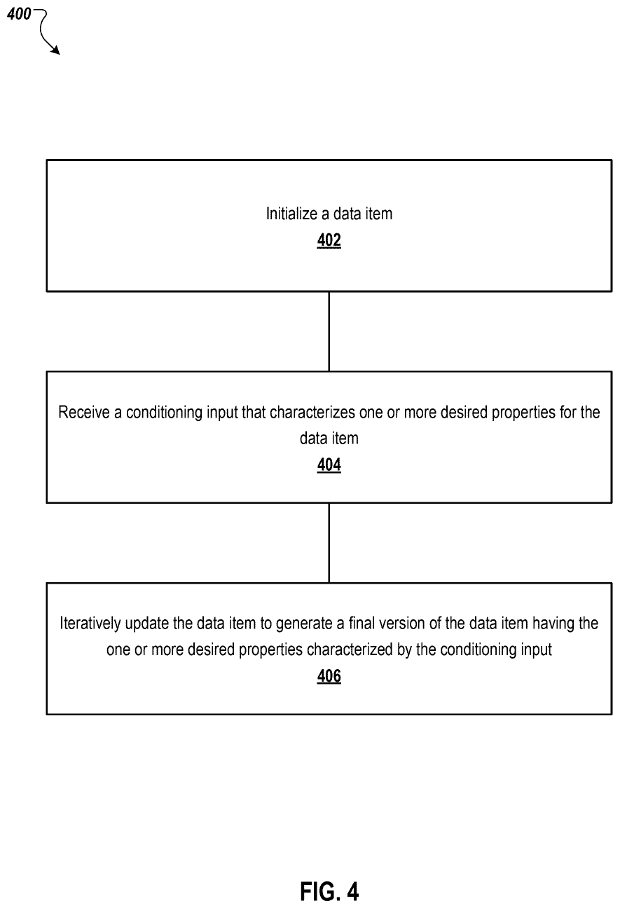

FIG. 4 illustrates an example method 400 for generating a final version of the data item having one or more desired properties characterized by the conditioning input. In some examples, the method 400 is performed by a system with one or more processors and non-transitory computer-readable media (e.g., memory) encoded with instructions that when executed by the one or more processors, cause the one or more processors to perform the method 400. Some examples include non-transitory computer-readable media encoded with instructions that cause one or more processors executing the instructions to perform the method 200. The method 400 includes the operation 402, 404, and 406.

At the operation 402, the computing device initializes a data item. As discussed, examples of the data item include an image, an audio signal, or a text sample.

At the operation 404, the computing device receives a conditioning input that characterizes one or more desired properties for the data item. In some examples, the conditioning input includes a fixed-size embedding that encodes semantic information from a text or image sample.

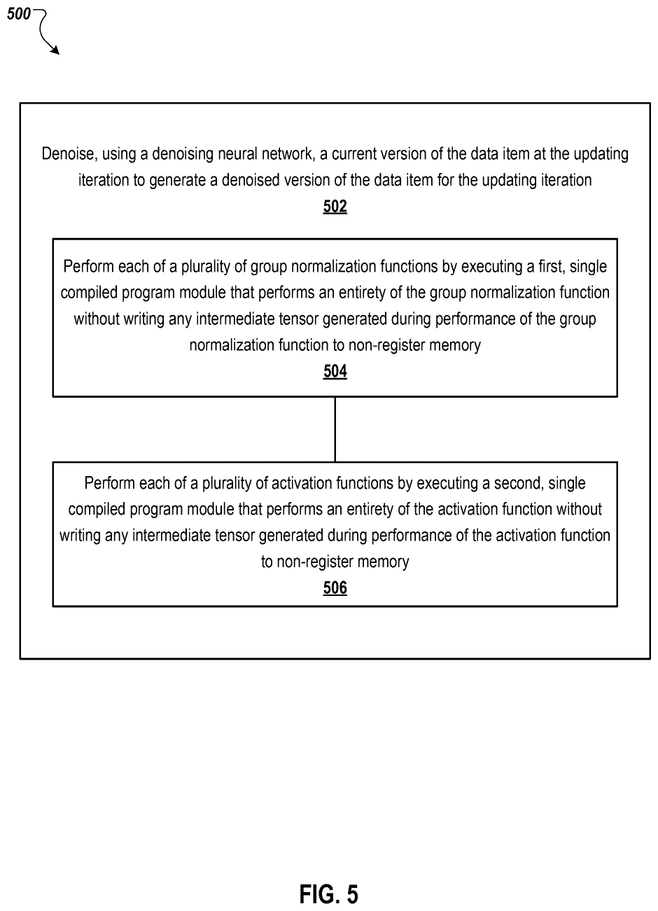

At the operation 406, the computing device iteratively updates the data item to generate a final version of the data item having the one or more desired properties characterized by the conditioning input. In some examples, iteratively updating, at each of the updating iterations includes denoising, using a denoising neural network, a current version of the data item at the updating iteration to generate a denoised version of the data item for the updating iteration. In some examples the denoising is performed using the method 500 illustrated and described in reference to FIG. 5.

The final version of the data item can be provided as output. Examples for providing the final version of the data item as output includes storing the final version of the data item in a memory device, displaying the final version of the data item as an image, playing the final version of the data item as an audio or video stream, presenting the final version of the data item as text, or providing the final denoised version of the data item to a decoding model for conversion from an embedding space to a text, image, audio, or video data item. In some examples, providing for output the final version of the data item includes processing a final output of the denoising neural network with an image decoding model to generate an image representative of the final version of the data item.

FIG. 5 illustrates an example method 500 for generating a denoised version of a data item for an updating iteration. In some examples, the method 500 is executed iteratively as part of the operation 406, illustrated and described in reference to FIG. 4. The method 500 includes the operation 502, 504, and 506.

At the operation 502, the computing device denoises, using a denoising neural network, a current version of the data item at the updating iteration to generate a denoised version of the data item for the updating iteration. In some examples, the denoising neural network is based on a Unet neural network architecture. In some examples, denoising the current version of the data item includes performing multiple convolution operations. Some or all of the convolution operations can be carried out using Winograd convolution.

In some examples, the current version of the data item includes the initialized data item at an initial updating iteration or comprises the denoised version of the data item from a preceding updating iteration for each updating iteration after the initial updating iteration.

At the operation 504, the computing device performs each of multiple group normalization functions by executing a first, single compiled program module that performs an entirety of the group normalization function without writing any intermediate tensor generated during performance of the group normalization function to non-register memory.

At the operation 506, the computing device performs each of multiple activation functions by executing a second, single compiled program module that performs an entirety of the activation function without writing any intermediate tensor generated during performance of the activation function to non-register memory. In some examples, the activation functions include a Gaussian Error Linear Unit (GELU).

In some examples, the first, single compiled program module is implemented as a first graphics processing unit (GPU) shader and the second, single compiled program module is implemented as a second GPU shader. The first GPU shader is operable to be invoked to perform the entirety of the group normalization function responsive to a first GPU command. The second GPU shader is operable to be invoked to perform the entirety of the activation function responsive to a second GPU command.

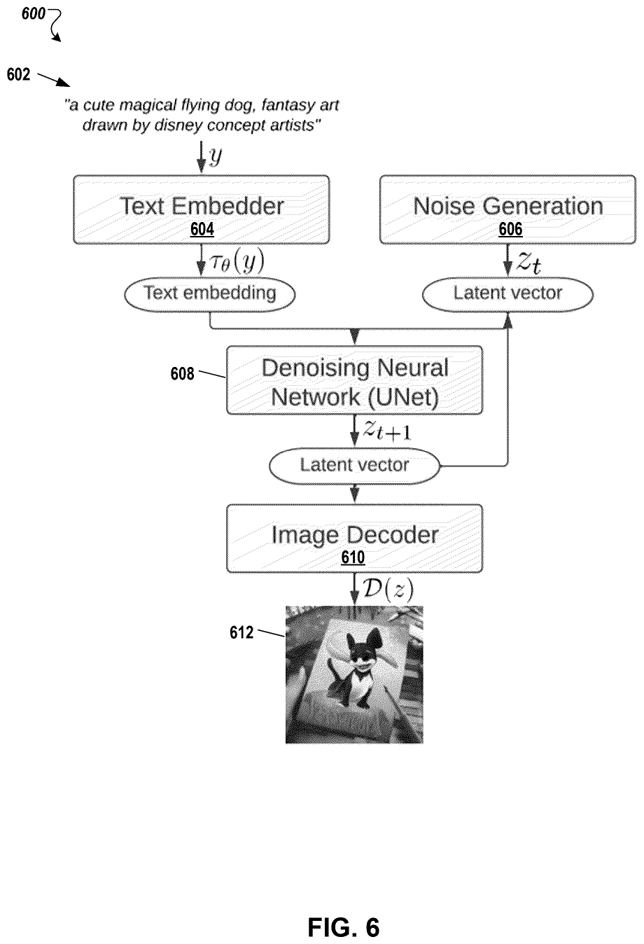

FIG. 6 illustrates a schematic diagram of a text-to-image model 600. The text-to-image model 600 generates an output image 612 from a text prompt 602 (e.g., a textual description) using large diffusion models. In some implementations, the specific architecture of the model is optimized. Other types of diffusion models can also be optimized using similar techniques. In the example shown, when performing inference with a text prompt 602, the process involves guiding the reverse diffusion process using additional conditioning based on the desired textual description. The model 600 includes a text embedder 604, a noise generator 606, a denoising neural network 608, and an image decoder 610.

In some examples, the text embedder 604 encodes the text prompt 602 to create an embedded vector representing the semantics of the input prompt 602. In some examples, the text embedder 604 uses a contrastive language-image pre-training (CLIP) model to encode the text prompt, y, resulting in a high-dimensional embedding vector, τ_{θ} (y), that encapsulates the semantics of the input prompt 602. The embedding is employed as input to the denoising neural network 608, furnishing conditional guidance for the reverse diffusion process.

The noise generator 606 supplies the random noise in the latent space, z, which functions as the initiation point for the reverse diffusion process.

The denoising neural network 608 approximates conditional distributions of the form p(z|y), utilizing a conditional denoising autoencoder, [symbol] _{θ}(zₜ, t, τ_{θ}(y)). Each iteration t employs the UNet architecture. The cross-attention mechanism is adopted to operate on the latent space and the text embedding vector, predicting a denoised version of the input zₜ during the iterative procedure.

The image decoder 610 reconstructs the output image 612 from the latent vector. In some examples, the reverse diffusion process is conducted in the latent space: z=ε(x)∈R^{h×w×c}, where x∈R^{H×W×C} represents the RGB image space. Once the process is completed, the image decoder 610 is used to reconstructs the RGB image from the latent vector: \hat{x}=D(\hat{z}).

Some implementations include applying one or more optimization techniques to enhance the performance of the model 600. Some of these optimizations include GPU-aware optimizations.

Some example optimizations include specialized kernels for group norm and gaussian error linear unit (GELU). Group normalization (GN) is implemented throughout the UNet architecture. This normalization technique works by dividing the channels of a feature map into smaller groups and normalizing each group independently, making GN less dependent on the batch size and more suitable for a wide range of batch sizes and network architectures. Each feature value xᵢ is normalized by the group mean μg and variance σg of the group it belongs to using the following equation \hat{x}_{I}=(1/σg (xᵢ−μg). Rather than executing the aforementioned operations, which involves “reshape”, “mean”, “variance”, “normalize”, sequentially, this optimization includes using a unique kernel in the form of a GPU shader that executes all of them in a single GPU command without any intermediate tensors. The Gaussian Error Linear Unit (GELU) serves as an activation function in the model, containing numerous numerical computations such as multiplications, addition, and the Gaussian error function, for example as shown in the following equation: GELU(x)=(x/2) [1+erf(x/square root (sqrt)(2))]. We implemented a dedicated shader to consolidate these numerical computations and its accompanied split and multiplication ops, enabling their execution in a single draw call.

In some examples, the model 600 includes a transformer (e.g., to facilitate the modeling of the conditional distribution (P(z|τ_{θ}(y)). In some examples, optimizations are applied to the transformer to improve the computational and memory complexity.

One such example, optimization to approve the attention module efficiency includes the use of a partially fused Softmax. The attention computation is adopted in the intermediate layers of the UNet: Attention (Q,K,V)=softmax (QK^{t}/sqrt(d))×V, where Q∈R^{N×d}; K,V∈R^{M×d}, corresponding to the query, key, and value matrices and typically N, M, are larger than d.

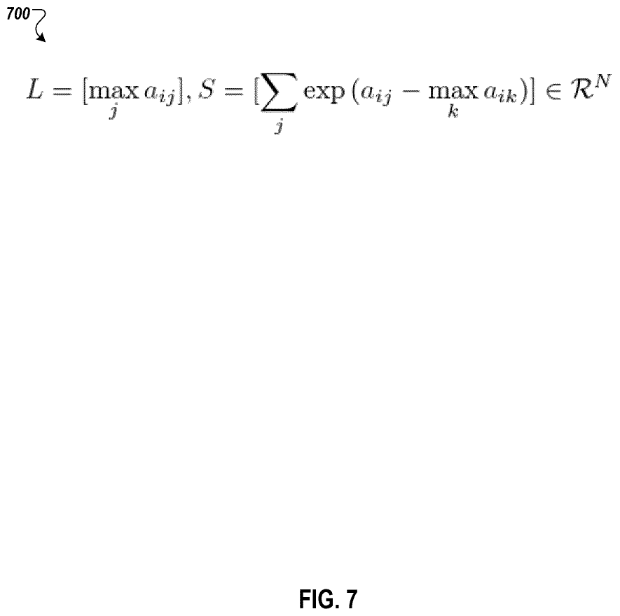

The softmax operation performed on the matrix A=(QK^{T}/sqrt (d))∈R^{N×M} can be partitioned into two steps: 1) reduction operations; 2) element-wise operations. The reduction operations refer to the calculation of the maximum values of each row in A and its modified exponential sum S, as shown in the equation 700 shown in FIG. 7. Subsequently, the element-wise operation is employed to normalize the values in A utilizing the vectors L and S.

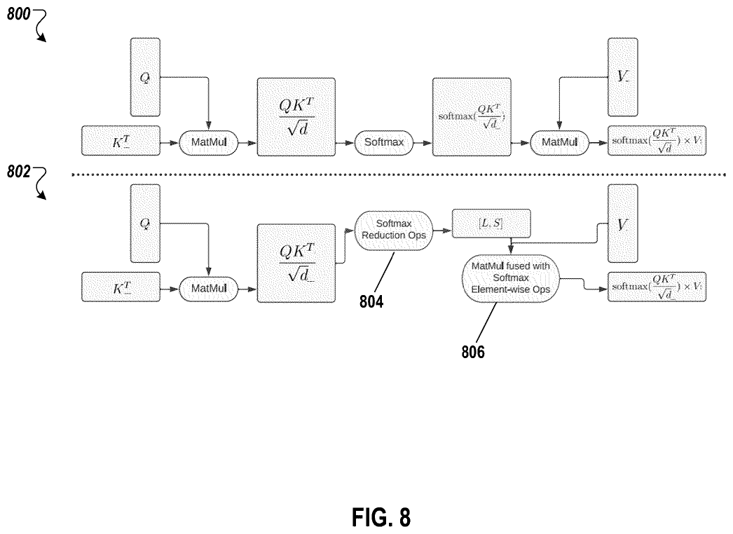

In some examples, in order to avoid executing the whole softmax computation on the large matrix A, a GPU shader is implemented for the reduction operations to compute the L and S vectors, resulting in a tensor of size N×2. The element-wise softmax computation is then fused with the following matrix multiplication involving matrix V. This approach can reduce the memory footprint of the intermediate tensors and overall latency. For example, FIG. 8 illustrates an optimized softmax implementation at 802 as compared to an implementation 800 for applying softmax directly to the matrix (QK^{T}/sqrt(d)). The optimized implementation 802 has a reduced memory footprint and computational complexity as compared to the implementation 800 because, in part, of the modules 804 (for the reduction operations) and 806 (for the element-wise operations).

The parallelism of the computation mapping from A to L; S is limited, as the number of elements in the resulting tensors is considerably smaller than those in the input tensor A. To enhance parallelism and further decrease latency, the reduction operations are partitioned into multiple stages by grouping the elements in A into blocks. The calculations are performed on each block, which are then reduced to the final result. By employing meticulously designed threading and memory cache management, this multi-stage implementation can be finished with a single GPU command and leads to additional latency reduction.

In some examples, the attention module's efficiency is improved using FlashAttention. FlashAttention is an IO-aware, exact attention algorithm that utilizes tiling to minimize memory reads/writes between GPU high bandwidth memory (HBM) and on-chip SRAM. Flash attention improves the attention module latency (or reduced computational complexity) without sacrificing model quality. The FlashAttention approach results in fewer HBM accesses than standard attention, making it optimal for a range of SRAM sizes and improving overall efficiency.

In some examples, FlashAttention kernel is highly register-intensive. In these examples, FlashAttention can selectively employ this technique (e.g., for attention matrices with dimension d=40) on select GPUs. In other cases, the partially fused softmax described in the previous section is utilized.

In some examples, the attention module's efficiency is improved using Winograd convolution. Winograd convolution transforms the convolution operation into a series of matrix multiplications. In some examples, the system, by choosing the transformation matrices, can reduce many of the required multiplications, leading to a more efficient computation. In some examples, this may introduce increased memory consumption and numerical errors, particularly when using larger tile sizes. The backbone of some diffusion models relies heavily on 3×3 convolution layers, especially in the image decoder, where they can comprise over 90% of the layers. In some of these examples a 4×4 tile size is selected because it provides an optimal balance between computational efficiency and memory utilization. In some examples, Winograd is selectively applied based on heuristic rules, only where it would produce profitable results, to further maximize its efficacy.

In some implementations, the denoising or diffusion neural networks referenced in this specification employ architectures based on the denoising or diffusion models described in Rombach et al., “High-resolution image synthesis with latent diffusion models” (2021), available at https://arxiv.org/abs/2112.10752, and the U-Net architecture described in Ronneberger et al., “U-Net: Convolutional Networks for Biomedical Image Segmentation” (2015), available at https://arxiv.org/abs/1505.04597. The entire contents of both papers are incorporated by reference into the disclosure of the present specification.

In this specification, the terms “row” and “column” refer to respective dimensions of a matrix or tensor. It should be understood that the techniques disclosed in this specification apply equally with respect to matrices and tensors whose elements that have been identified as forming rows are instead provided in columns or other dimensions and vice versa.

Additional aspects of the subject matter disclosed in this specification include systems having one or more processors and one or more non-transitory computer-readable media having instructions stored thereon that, when executed by the one or more processors, cause performance of any of the processes and methods described herein.

Certain novel aspects of the subject matter of this specification are set forth in the claims below.

This specification uses the term “configured” in connection with systems and computer program components. For a system of one or more computers to be configured to perform particular operations or actions means that the system has installed on its software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a standalone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, comprising:
identifying a data item;
processing the data item with a denoising neural network to generate a denoised version of the data item, the denoising neural network defining a self-attention mechanism, wherein generating the denoised version of the data item comprises invoking the self-attention mechanism to process a set of attention inputs to generate an attention output by:
obtaining a query matrix Q that contains elements representing a set of queries q, a key matrix K that contains elements representing a set of keys k, and a value matrix V that contains elements representing a set of values v corresponding to the set of keys k;
generating an attention matrix A by calculating a product of the query matrix Q and the key matrix K;
executing a first, single compiled program module that calculates, for each row in the attention matrix A, a respective maximum value L among the elements in the row and a modified exponential sum S for the elements in the row, wherein the respective maximum values L and the respective modified exponential sums S are stored in a reduced matrix R; and
executing a second, single compiled program module that both performs an element-wise softmax function on the elements of the reduced matrix R and multiplies the result of the element-wise softmax function by the value matrix V to produce the attention output.

2. The method of claim 1, wherein the data item comprises at least one of an image, an audio signal, or a text sample.

3. The method of claim 1, comprising iteratively denoising the data item to generate a final denoised version of the data item, wherein the iterative denoising is guided by a conditioning input that characterizes one or more desired properties for denoising the data item.

4. The method of claim 1, wherein generating the attention matrix A comprises calculating a scaled product of the query matrix Q and a transposed version of the key matrix K.

5. The method of claim 1, wherein the reduced matrix R has fewer elements than the attention matrix A, and wherein performing the element-wise softmax function on the reduced matrix R is less computationally expensive than if the element-wise softmax function were performed on the attention matrix A.

6. The method of claim 1, wherein the first, single compiled program module is implemented as a graphics processing unit (GPU) shader.

7. The method of claim 6, wherein the GPU shader is operable to calculate all of the Land S values for storage in the reduced matrix R responsive to a single GPU command without writing any intermediate tensors to non-register memory in the course of calculating all of the L and S values.

8. The method of claim 1, wherein the second, single compiled program module is implemented as a graphics processing unit (GPU) shader.

9. The method of claim 8, wherein the GPU shader is operable to both perform the element-wise softmax function on the elements of the reduced matrix R and multiply the result of the element-wise softmax function by the value matrix V to produce the attention output responsive to a single GPU command without writing any intermediate tensors to non-register memory in the course of calculating all of the L and S values.

10. The method of claim 1, comprising providing for output a final denoised version of the data item.

11. The method of claim 10, wherein providing for output the final denoised version of the data item comprises storing the final denoised version of the data item in a memory device, displaying the final denoised version of the data item as an image, playing the final denoised version of the data item as an audio or video stream, presenting the final denoised version of the data item as text, or providing the final denoised version of the data item to a decoding model for conversion from an embedding space to a text, image, audio, or video data item.

12. The method of claim 1, comprising:
grouping the elements of the reduced matrix R into a plurality of blocks B;
executing the second, single compiled program module with respect to each block B of the plurality of blocks B to separately perform the element-wise softmax function on the elements of each block B and to multiple the result of the element-wise softmax function with respect to each block B by the value matrix V; and
combining results of the execution of the second, single compiled program module for each block B to produce the attention output.

13. The method of claim 12, wherein the second, single compiled program module that is executed with respect to each block B is executed on a different processing device, wherein at least some of the executions for different blocks B are parallelized.

14. The method of claim 1, wherein processing the data item with the denoising neural network comprises performing a plurality of convolution operations, wherein all or some of the plurality of convolution operations are carried out using Winograd convolution.

15. The method of claim 14, comprising selectively using Winograd convolution to perform only a subset of the plurality of convolution operations.

16. A system, comprising:
one or more processors; and
one or more non-transitory computer-readable media encoded with instructions that, when executed by the one or more processors, cause the one or more processors to:
identify a data item;
process the data item with a denoising neural network to generate a denoised version of the data item, the denoising neural network defining a self-attention mechanism, wherein to generate the denoised version of the data item comprises invoking the self-attention mechanism to process a set of attention inputs to generate an attention output by:
obtaining a query matrix Q that contains elements representing a set of queries q, a key matrix K that contains elements representing a set of keys k, and a value matrix V that contains elements representing a set of values v corresponding to the set of keys k;
generating an attention matrix A by calculating a product of the query matrix Q and the key matrix K;
executing a first, single compiled program module that calculates, for each row in the attention matrix A, a respective maximum value L among the elements in the row and a modified exponential sum S for the elements in the row, wherein the respective maximum values L and the respective modified exponential sums S are stored in a reduced matrix R; and
executing a second, single compiled program module that both performs an element-wise softmax function on the elements of the reduced matrix R and multiplies the result of the element-wise softmax function by the value matrix V to produce the attention output.

17. A method performed by one or more computers, the method comprising:
initializing a data item;
receiving a conditioning input that characterizes one or more desired properties for the data item;
iteratively updating the data item to generate a final version of the data item having the one or more desired properties characterized by the conditioning input, the iterative updating comprising, at each of a plurality of updating iterations:
denoising, using a denoising neural network, a current version of the data item at the updating iteration to generate a denoised version of the data item for the updating iteration, including:
(i) performing each of a plurality of group normalization functions by executing a first, single compiled program module that performs an entirety of the group normalization function without writing any intermediate tensor generated during performance of the group normalization function to non-register memory; or
(ii) performing each of a plurality of activation functions by executing a second, single compiled program module that performs an entirety of the activation function without writing any intermediate tensor generated during performance of the activation function to non-register memory,
wherein the denoising is guided at least in part by the conditioning input; and
providing for output the final version of the data item.

18. The method of claim 17, wherein:
the first, single compiled program module is implemented as a first graphics processing unit (GPU) shader and the second, single compiled program module is implemented as a second GPU shader;
the first GPU shader is operable to be invoked to perform the entirety of the group normalization function responsive to a first GPU command; and
the second GPU shader is operable to be invoked to perform the entirety of the activation function responsive to a second GPU command.

19. The method of claim 17, wherein each of the plurality of activation functions comprises a Gaussian Error Linear Unit (GELU).

20. The method of claim 17, wherein the current version of the data item comprises the initialized data item at an initial updating iteration or comprises the denoised version of the data item from a preceding updating iteration for each updating iteration after the initial updating iteration.

21. The method of claim 17, wherein providing for output the final version of the data item comprises storing the final version of the data item in a memory device, displaying the final version of the data item as an image, playing the final version of the data item as an audio or video stream, presenting the final version of the data item as text, or providing the final denoised version of the data item to a decoding model for conversion from an embedding space to a text, image, audio, or video data item.

22. The method of claim 17, wherein denoising the current version of the data item comprises performing a plurality of convolution operations, wherein all or some of the plurality of convolution operations are carried out using Winograd convolution.

23. The method of claim 17, wherein the conditioning input that characterizes the one or more desired properties for the data item comprises a fixed-size embedding that encodes semantic information from a text or image sample.

24. The method of claim 17, wherein the denoising neural network is based on a UNet neural network architecture.

25. The method of claim 17, wherein providing for output the final version of the data item comprises processing a final output of the denoising neural network with an image decoding model to generate an image representative of the final version of the data item.
